(19) United States
(12) Patent Application Publication
(10) Pub. No.: US 2006/0196585 A1
(43) Pub. Date: Sep. 7, 2006

(54) Additives for Suppressing Tungsten Leachability

(75) Inventors: Hans-Joachim Lunk, Towanda, PA (US); Ricky D. Morgan, Milan, PA (US); Henry J. Stevens, Athens, PA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/306,705

(22) Filed: Jan. 9, 2006

Related U.S. Application Data
(60) Provisional application No. 60/593,536, filed on Jan. 24, 2005.

(51) Int. Cl. C22B 34/30; C01G 41/00; C01G 37/14; C22C 27/04

(52) U.S. Cl. 148/423; 423/53; 423/58; 423/61

(57) ABSTRACT

The leachability of tungsten in an aqueous medium may be suppressed by combining tungsten metal with a metal oxide or metal salt that will form an insoluble tungsten-containing compound when the mixture is brought into contact with an aqueous medium. The additive is preferably present in an amount from about 1 weight percent (wt. %) to about 10 weight percent of the tungsten of the tungsten. Preferred additives are lead oxide and calcium sulfate.

### CROSS REFERENCE TO RELATED APPLICATION

This application claims the benefit of U.S. Provisional Application No. 60/593,536, filed Jan. 24, 2005.

### BACKGROUND OF THE INVENTION

The use of tungsten powder or pressed tungsten powder compacts in pure or mixtures with other powders under natural conditions in the presence of water and oxygen (e.g., air or dissolved oxygen) leads to the formation of a water-soluble, tungsten-containing species. The first step of the reaction can be described as follows:
W+H₂O+1.5 O₂→WO₄²⁻+2 H⁺.

The monotungstate ion, WO₄²⁻, reacts with H⁺, resulting in the formation of the soluble metatungstate anion [H₂W₁₂O₄₀]⁶⁻+8H₂O.
12 WO₄²⁻+18 H^{+→[H}₂W₁₂O₄₀]⁶⁻+8 H₂O.

The formation of this polyoxometalate anion is detectable by its typical UV absorption maximum at 256 nm (molar extinction coefficient, ε₂₅₆=3.8×10⁴ L(mol·cm)⁻¹).

### SUMMARY OF THE INVENTION

It has been discovered that the leachability of tungsten in an aqueous medium may be suppressed by using a suitable additive that will cause an insoluble tungsten-containing compound to form under conditions which would normally cause leaching of the tungsten. As used herein, insoluble means no significant solubility in the relevant aqueous medium under ambient conditions.

More particularly, tungsten metal is combined with a metal oxide or metal salt that will form the insoluble tungsten-containing compound when the mixture is brought into contact with an aqueous medium, preferably having a pH from about 4 to about 9. The additive is present preferably in an amount from about 1 weight percent (wt. %) to about 10 weight percent of the tungsten, and, more preferably, from about 1 wt. % to about 2 wt. % of the tungsten.

The additive must be more soluble in the aqueous medium than the insoluble tungsten-containing compound to be formed. Possible additives include metal oxides, such as lead oxide, and metal salts, such as calcium sulfate or lead nitrate. Preferably, the insoluble tungsten-containing compounds that are formed are tungstates, and, more preferably, lead tungstate (solubility at 25° C. of 2.7×10⁻⁶ mol/L) or calcium tungstate (solubility at 25° C. of 4.3×10⁻⁵ mol/L).

In a preferred embodiment, the invention may be carried out by mixing powdered tungsten metal with a powdered form of the additive. A binder material may be also be added for facilitating the pressing of a tungsten-containing article. Or alternatively, it may be possible for some tungsten/additive powder mixtures to be pressed directly into the desired shape without an additional binder depending upon the mechanical strength needed for the pressed article.

### DETAILED DESCRIPTION OF THE INVENTION

For a better understanding of the present invention, together with other and further objects, advantages and capabilities thereof, reference is made to the following disclosure and appended claims.

Ten-gram amounts of a tungsten metal powder (particle size>3 micrometers) were mixed separately with various amounts of lead oxide, calcium sulfate, and barium sulfate and added to 500-ml volumes of an aqueous buffer solution in 1-liter NALGENE© (PP) Erlenmeyer flasks. The buffer solution having a pH of 7.2 was prepared by dissolving 4.03 mg KCl, 50.6 mg CaSO₄·2H₂O, 123.2 mg MgSO₄·7H₂O, 96.0 mg NaHCO₃, and 209.3 mg of a noncomplexing tertiary amine, 3-(N-morpholino) propanesulfonic acid (MOPS) per liter of water. For a control, 10 g of tungsten metal powder alone was also placed in 500 ml of the aqueous buffer solution.

In another series of tests, 10-g amounts of tungsten metal powder were placed in 500-ml volumes of an unbuffered aqueous solution of lead nitrate (pH 4.4) in 1-liter NALGENE© (PP) Erlenmeyer flasks. In this case, the additive amount in Table 1 is given in terms of the molarity of the lead nitrate solution. Other lead salts that may be used based on their solubilities include lead bromide, lead chloride, lead fluoride, lead sulfate and lead oxalate.

The 1 -liter flasks containing the samples were loosely covered with an aluminum foil and continuously shaken in a dark, thermostated room (72° F.) with a LAB-LINE® Force orbital open air shaker, Model 4690, for a period of 28 days. Periodic 25-ml samples of the leachate solutions were taken and analyzed for pH, oxygen content, and tungsten content at 7, 14, 21, and 28 days. A constant oxygen concentration of 8.3±0.2 mg/liter was observed for the entire testing period of 28 days.

The results of the leach tests are shown in Table 1. Weight percentages of the additives are based on the amount of tungsten. As can be seen from the Control sample, the amount of tungsten in the leachate increases from 0.32% of the initial tungsten at 7 days to 0.78% at 28 days. In most cases, the leachability of tungsten is suppressed compared to the Control, and in many cases is zero (i.e., below the detection limit of 0.4 mg W/L). The addition of lead oxide showed a distinct improvement at levels of 2 wt. % or higher. At 1 wt. %, lead oxide had only a minor suppressing effect on tungsten's leachability. In some cases, e.g., 10 wt. % calcium sulfate, the amount of leached tungsten actually decreased over time indicating that the amount of additive entering solution increased as time progressed.

The results for the sample containing barium sulfate demonstrate that an additive that has too low a solubility will not suppress the leachability of the tungsten.

TABLE I
Effect of various additives on tungsten leachability
(in % based on initial W amount)

| | | | Starting | % W | % W | % W | % W |
|---|---|---|---|---|---|---|---|
| Sample | Additive | | pH | 7-day | 14-day | 21-day | 28-day |
| | | Additive | | | | | |
| | | Amount | | | | | |
| | | (wt. %) | | | | | |
| W powder | — | — | 7.2 | 0.32 | 0.49 | 0.65 | 0.78 |
| (control) | | | | | | | |
| W powder | lead oxide | 1 | 7.2 | 0.28 | 0.47 | 0.59 | 0.68 |
| W powder | lead oxide | 2 | 7.2 | 0.00 | 0.004 | 0.16 | 0.21 |
| W powder | lead oxide | 5 | 7.2 | 0.00 | 0.00 | 0.00 | 0.02 |
| W powder | calcium sulfate | 1 | 7.2 | 0.28 | 0.25 | 0.21 | 0.24 |
| W powder | calcium sulfate | 10 | 7.2 | 0.14 | 0.06 | 0.04 | 0.03 |
| W powder | barium sulfate | 10 | 7.2 | 0.30 | 0.43 | 0.54 | — |
| | | Additive | | | | | |
| | | Conc. | | | | | |
| W powder | Pb(NO₃)₂ | 0.01M | 4.4 | 0.00 | 0.00 | 0.00 | 0.00 |
| W powder | Pb(NO₃)₂ | 0.001M | 4.4 | 0.00 | 0.00 | 0.00 | 0.00 |
| W powder | Pb(NO₃)₂ | 0.0005M | 4.4 | 0.00 | 0.00 | 0.00 | 0.04 |
| W powder | Pb(NO₃)₂ | 0.0001M | 4.4 | 0.00 | 0.04 | 0.13 | 0.23 |

While embodiments of the present invention have been described in the foregoing specification, it is to be understood that the present invention is defined by the following claims when read in light of the specification.

What is claimed is:

1. A method of suppressing the leachability of tungsten, comprising:
combining tungsten metal with a metal oxide or metal salt, contacting the combination with an aqueous medium whereby an insoluble tungsten-containing compound is formed.

2. The method of claim 1 wherein the metal oxide is lead oxide.

3. The method of claim 1 wherein the metal salt is lead nitrate or calcium sulfate.

4. The method of claim 1 wherein the insoluble tungsten-containing compound is lead tungstate or calcium tungstate.

5. The method of claim 1 wherein the pH of the aqueous medium is from about 4 to about 9.

6. The method of claim 1 wherein the amount of the metal oxide or metal salt is from about 1 weight percent to about 10 weight percent of the tungsten.

7. The method of claim 1 wherein the amount of the metal oxide or metal salt is from about 1 weight percent to about 2 weight percent of the tungsten.

8. A powder mixture, comprising: a mixture of tungsten metal and a metal oxide or metal salt wherein the metal oxide or metal salt induces the formation of an insoluble tungsten-containing compound when the mixture is contacted with an aqueous medium.

9. The mixture of claim 8 wherein the metal oxide is lead oxide.

10. The mixture of claim 8 wherein the metal salt is lead nitrate or calcium sulfate.

11. The mixture of claim 8 wherein the insoluble tungsten-containing compound is lead tungstate or calcium tungstate.

12. The mixture of claim 8 wherein the pH of the aqueous medium is from about 4 to about 9.

13. The mixture of claim 8 wherein the amount of the metal oxide or metal salt is from about 1 weight percent to about 10 weight percent of the tungsten.

14. The mixture of claim 8 wherein the amount of the metal oxide or metal salt is from about 1 weight percent to about 2 weight percent of the tungsten.

15. A tungsten-containing article, comprising: tungsten metal and a metal oxide or metal salt wherein the metal oxide or metal salt induces the formation of an insoluble tungsten-containing compound when the article is contacted with an aqueous medium.

16. The article of claim 15 wherein the amount of the metal oxide or metal salt is from about 1 weight percent to about 10 weight percent of the tungsten.

17. The article of claim 15 wherein the amount of the metal oxide or metal salt is from about 1 weight percent to about 2 weight percent of the tungsten.

18. The article of claim 15 wherein the metal oxide is lead oxide.

19. The article of claim 15 wherein the metal salt is lead nitrate or calcium sulfate.

20. The article of claim 16 wherein the metal oxide is lead oxide.
